(19) United States
(12) Patent Application Publication
(10) Pub. No.: US 2017/0347625 A1
(43) Pub. Date: Dec. 7, 2017

(54) ANIMAL FEEDER

(71) Applicant: JOHN BISHOP, Charleston, SC (US)

(72) Inventor: JOHN BISHOP, Charleston, SC (US)

(21) Appl. No.: 15/175,086

(22) Filed: Jun. 7, 2016

(51) Int. Cl. A01K 5/02; A01K 5/01

(52) U.S. Cl. CPC A01K 5/0291; A01K 5/0107; A01K 5/0225

(57) ABSTRACT

A robust multiple compartment animal feeder. The device has multiple hoppers or containers, each of which is filled with feed. The device periodically releases a door, allowing food to fall from one of the hoppers. The use of a pin inserted into a latch allows substantial weight to be placed in the hopper. Pins are withdrawn from the latches by a line. The line periodically pulls one of the pins from a latch to release feed from the container with which the pin and latch are associated.

### FIELD OF THE INVENTION

The present invention relates to devices and methods for feeding animals.

### BACKGROUND OF THE INVENTION

Food is provided for animals by farmers, hunters, breeders and others. Generally, animals feed daily. Proper amounts of food should be dispensed periodically, and without providing too much food at one time.

Many hunters provide food for game, and particularly for larger game, such as deer. Hunters provide food in remote locations, and may provide food such as ears of corn strewn about the ground in animal habitat.

It is preferable to provide such food on a periodic basis to encourage a habit of deer or other animals visiting a specific location. Since the location may be remote, or at least inconvenient to visit on a frequent basis, there is a need for an automated feed dispensing device that will periodically dispense food without visitation to the feeding site by the operator.

If the feed is directed to large animals, it is desirable to dispense a large quantity of food. Several bushels of corn have substantial weight. Accordingly, the device must accommodate holding, and periodically dispensing, a substantial weight of animal feed. At the same time, the device should be able to withstand an outdoor, and potentially harsh, environment.

A device that periodically dispenses is also beneficial to farmers and ranchers who raise large animals. A preferred device should dispense food periodically and automatically.

### SUMMARY OF THE INVENTION

The invention is a robust multiple compartment animal feeder. The device has multiple hoppers or containers, each of which is filled with feed for animals. The device periodically releases a door, allowing feed to fall from a hopper. A pin inserted into a latch holds the hopper door closed, and allows feed having substantial weight to be placed in the hopper. Pins are sequentially withdrawn from latches by a line to release the feed. The line periodically pulls one of the pins from a latch to release feed from the container with which the pin and latch are associated.

### BRIEF DRAWING DESCRIPTION

FIG. 1 is a perspective view of an embodiment of the invention.

FIG. 2 shows the animal feeder of FIG. 1 with a first hopper door in an open position and the remainder of the hoppers in a closed position.

FIG. 3 shows the animal feeder of FIGS. 1 and 2 with all of the hopper doors in the open position.

FIG. 4 shows the animal feeder of FIG. 1 as a rear perspective view.

FIG. 5 is a partial view of the animal feeder showing a line connected to a plurality of pins holding the doors of the hoppers in a closed position.

FIG. 6 shows the animal feeder of FIG. 5, demonstrating a pin pulled from a latch of the first hopper by the line.

FIG. 7 is a sectioned view taken essentially along line 7-7 of FIG. 5.

FIG. 8 is a sectioned view taken essentially along line 8-8 of FIG. 6.

FIG. 9 is an enlarged view showing the line engaging two of the pins.

FIG. 10 is an enlarged view showing an embodiment of the line and pin assembly.

FIG. 11 shows the line attached to three pins according to an embodiment of the invention.

FIG. 12 demonstrates sequential releasing of pins associated with hoppers to sequentially open the doors of the hoppers.

FIG. 13 is a bottom plan view of the device with all pins in place and the hoppers in the closed position.

FIG. 14 shows the animal feeder of FIG. 13 with the pins disengaged from the doors.

FIG. 15 shows an embodiment of an electrically powered reel with line attached, and timer controls for actuation of the motor and reel.

### DESCRIPTION OF PREFERRED EMBODIMENTS

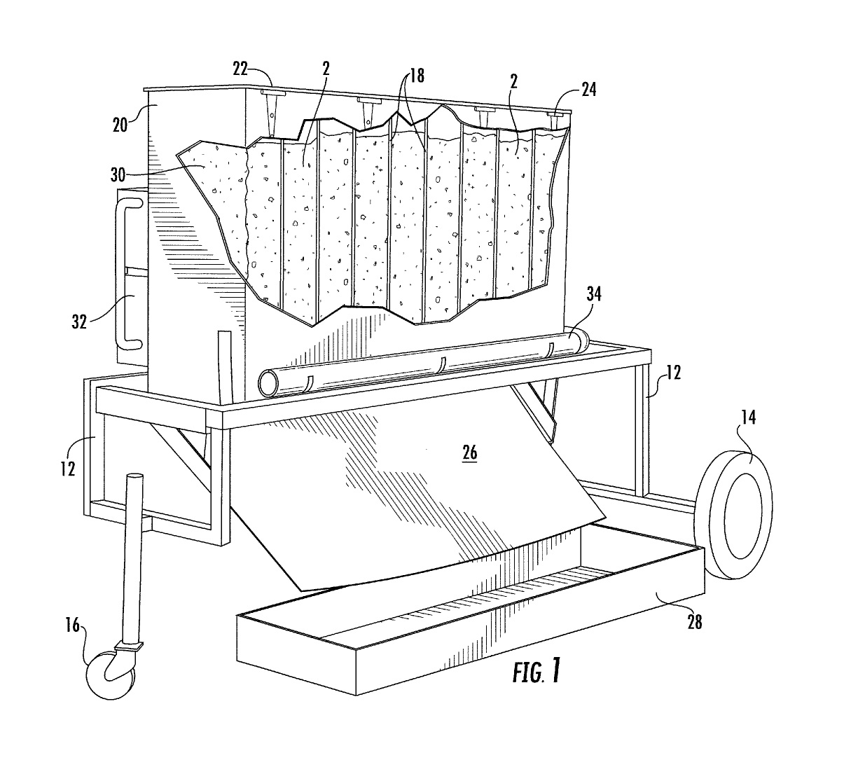

FIG. 1 shows a preferred embodiment of the device. The device comprises a frame 12. The frame may be mobile by providing wheels 14. A trailer hitch may be adapted to allow the device to be pulled by a motorized vehicle. A pivoting caster 16 may be provided on the front for steering and mobility of the frame.

A plurality of hoppers 2 is mounted on the frame 12. The hoppers may be positioned in a side by side configuration. The hoppers may be formed by inserting walls 18 between areas of the overall container 20 as shown in FIG. 1. The hoppers may be covered by one or more hinged doors 22 positioned over the storage areas of the hoppers. Hinges 24 are provided for the hinged top for opening and closing of the hinged top or hinged tops. The hinged tops provide weather protection, while also preventing unwanted access to the hoppers by animals. Optionally, a chute 26 may be provided for guiding animal feed 30 into a trough 28. In another embodiment, feed may be allowed to fall on the ground, and no trough is provided.

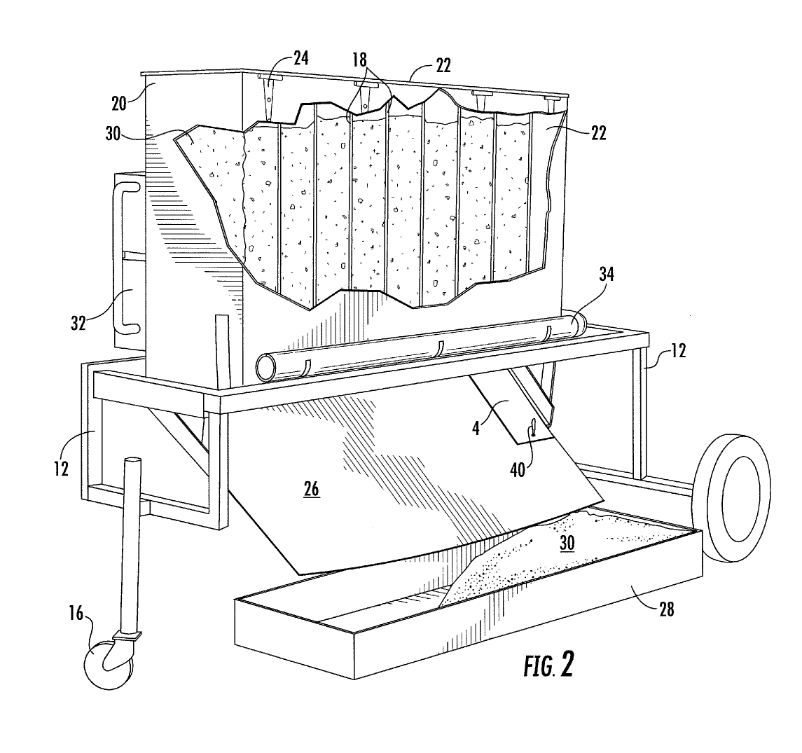

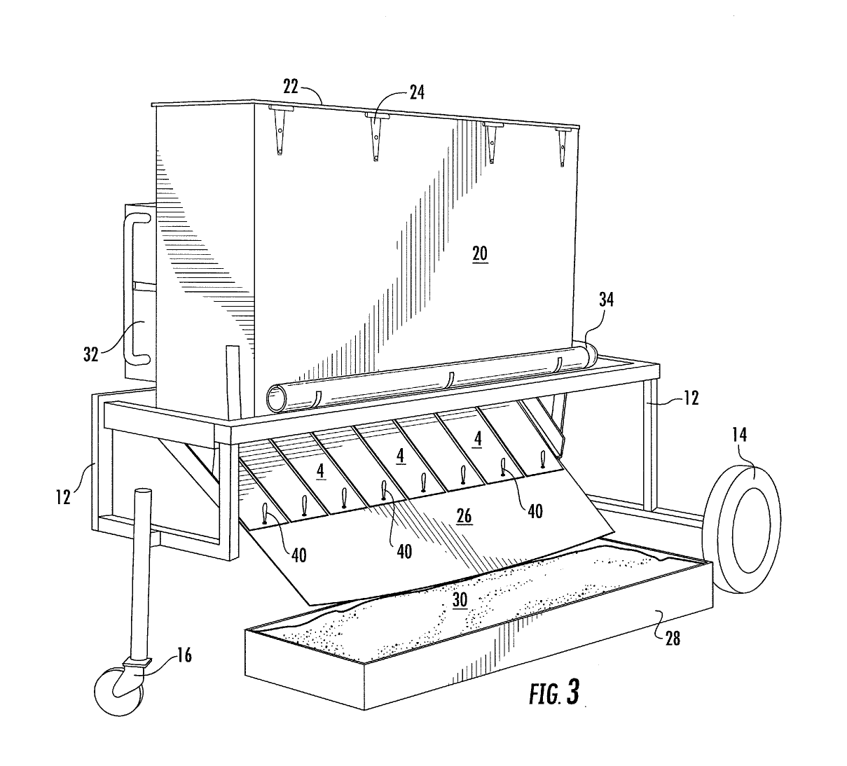

Each of the hoppers 2 has an associated door 4. It is preferred that the door is hinged on one side with the remaining three sides free, so that the hinged doors fall when released as shown in FIG. 2 and FIG. 3. FIG. 2 demonstrates sequential opening of the hoppers, with a first hopper open to allow the hinged door to fall away from the hopper, thereby permitting feed to fall from the hopper by gravity. Similarly, FIG. 3 demonstrates all of the doors in an open position so that all of the grain or other feed is dispensed from all of the hoppers.

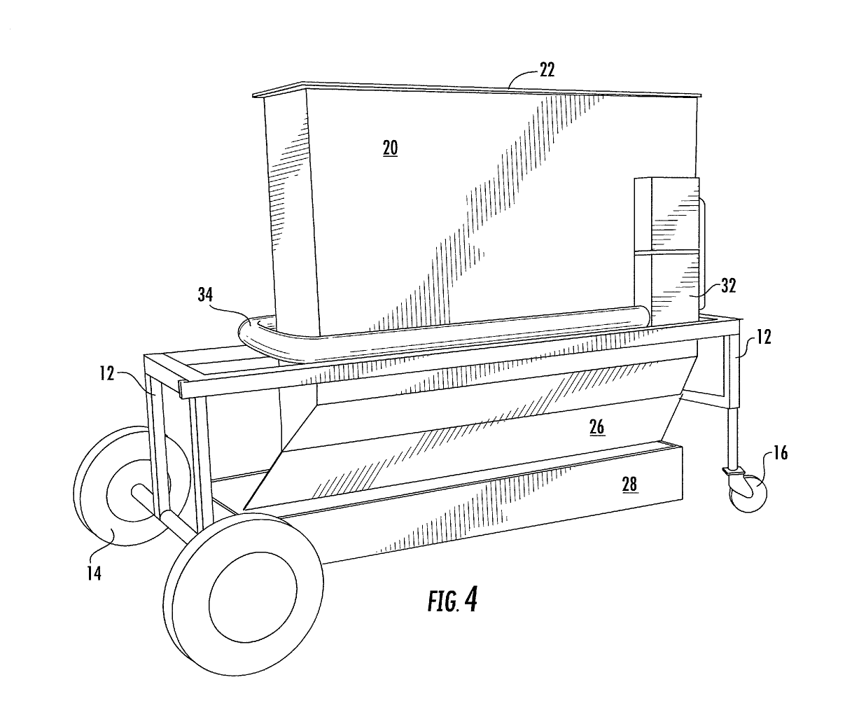

FIG. 4 is a perspective view showing the rear of the animal feeder of FIG. 1. A housing 32 for a motor 44, reel 46 and other electronics, is shown. A conduit 34 for the line 8 is also shown. The line is housed within the conduit and extends from the reel to the pins. The conduit may be formed of PVC pipe such as used for plumbing that is durable in outdoor environments.

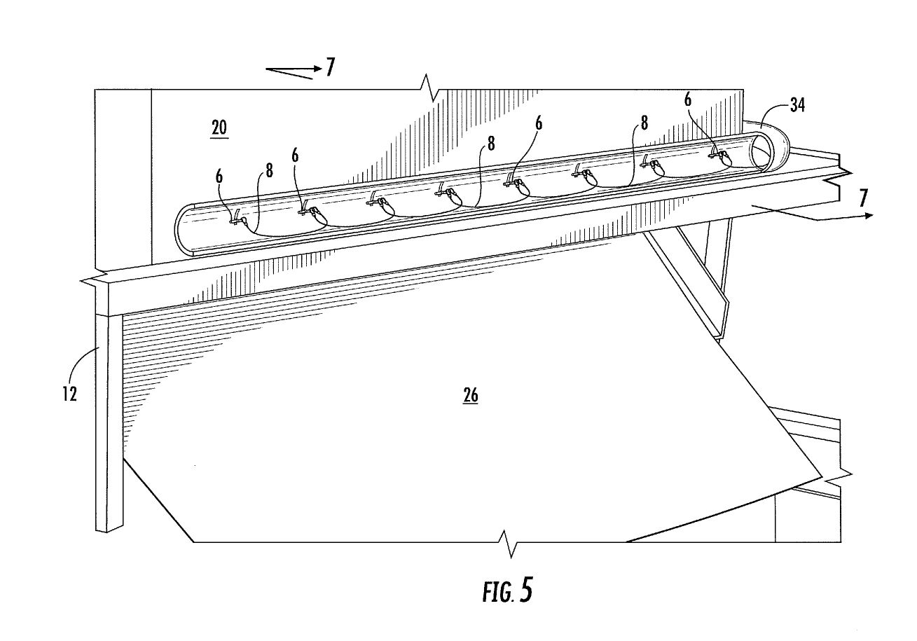

FIG. 5 demonstrates the structure that holds the hinged doors in the closed position against the storage area of each hopper. A plurality of pins 6 is attached to a line 8. Each of the pins engages a metal loop 40, which forms a latch for a container in the embodiment shown. Each metal loop is associated with one of the hinged doors. Each pin engages one metal loop, and all of the hinged doors are held in the closed position against the storage area of the hopper so as to prevent the feed from falling out of the hopper. Significantly, there is slack in the line between each of the pins as the pins engage its associated loop. In the embodiment shown, the metal loop is formed of corrosion resistant metal cable.

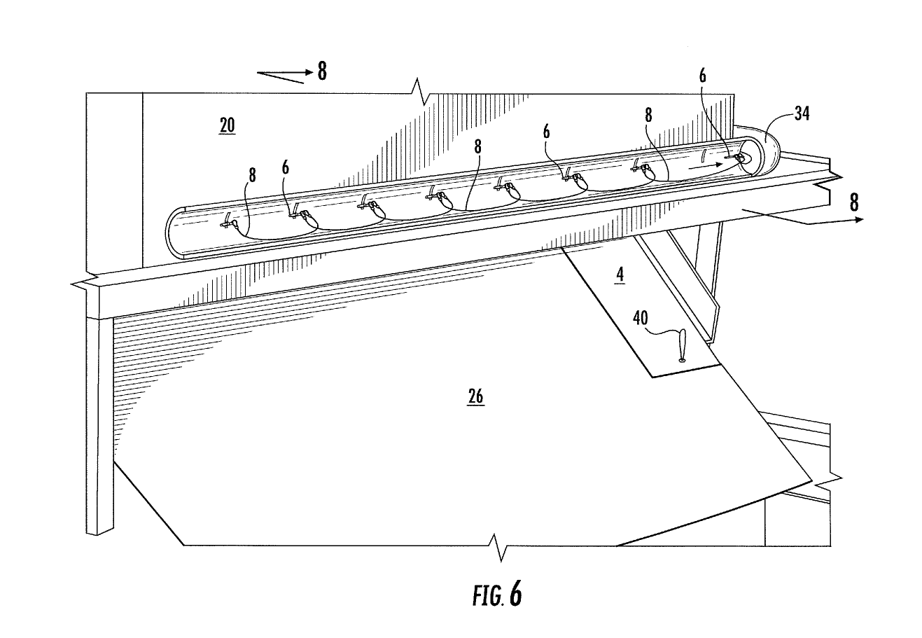

FIG. 6 demonstrates the line pulling the pin 6 from the first metal loop 40 so as to release the hinged door. An electric motor 44 (FIG. 15) may be actuated to rotate a reel 46 around which the line is wrapped as the motor rotates. As the reel takes up the line, the line is tightened and pulls the pin from the loop. The motor is actuated for a time period that is long enough to pull one pin at a time from its associated metal loop, but according to one embodiment, the motor is not actuated for a time period that will cause the next pin to be pulled from its associated loop. The time interval between actuation of the motor for sequential opening of the doors is user selectable, and may be controlled by a pre-set timer 48, or the motor and reel may be actuated and otherwise controlled on demand, such as by remote actuation.

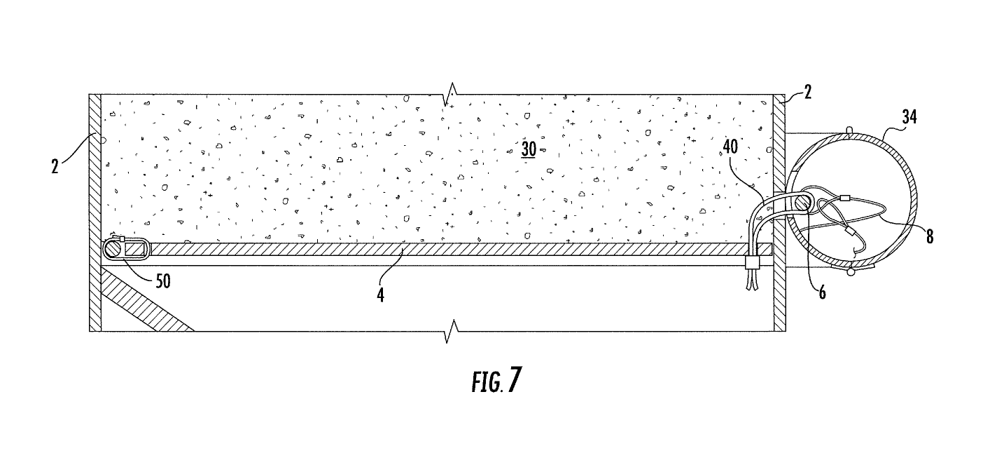

FIG. 7 shows an embodiment of operational elements of the device. FIG. 7 is a sectioned view that shows a hopper 2 and a door 4 for the hopper having a hinge 50. The door is in the closed position, so as to prevent feed 30 from falling from the storage area of the hopper. A latch, such as loop 40, is attached to the hinged door, generally opposite the hinge. The loop extends through the front of the hopper. The pin 6 extends through the loop when the hinged door is in a closed position. The line 8 is attached to the pin. The line and the pin are shown as being inside conduit 34.

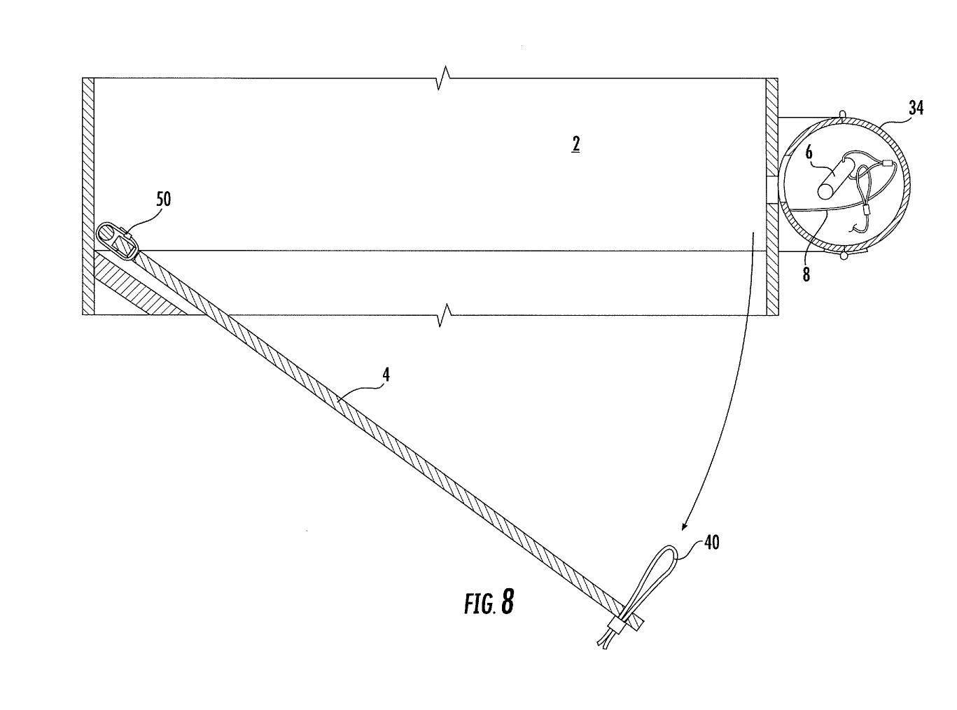

FIG. 8 shows the hopper of FIG. 7. FIG. 8 demonstrates the pin 6 being pulled by the line 8 so as to be pulled away from the loop 40. As the pin is pulled from the loop, the weight of the door 4 and the feed 30 push the door downwardly, with the door rotating about the hinge 50 to release the feed.

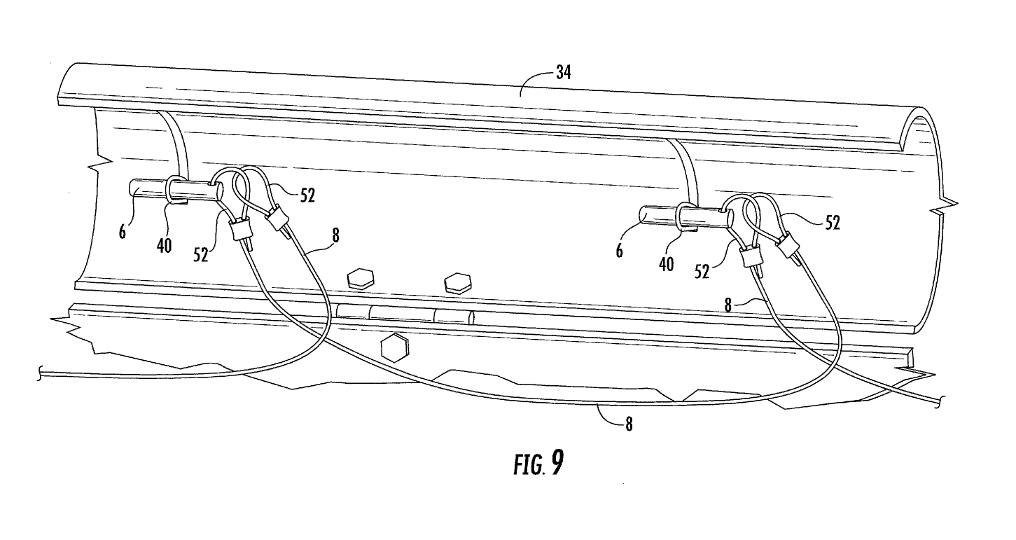

FIG. 9 shows the loop 40 extending through the conduit 34 for the line, with pins engaged in their associated loops to fold the hinged door in the closed position. Again, slack is provided in the line between the pins when the pins are engaged in the loop to hold the hinged door in the closed position.

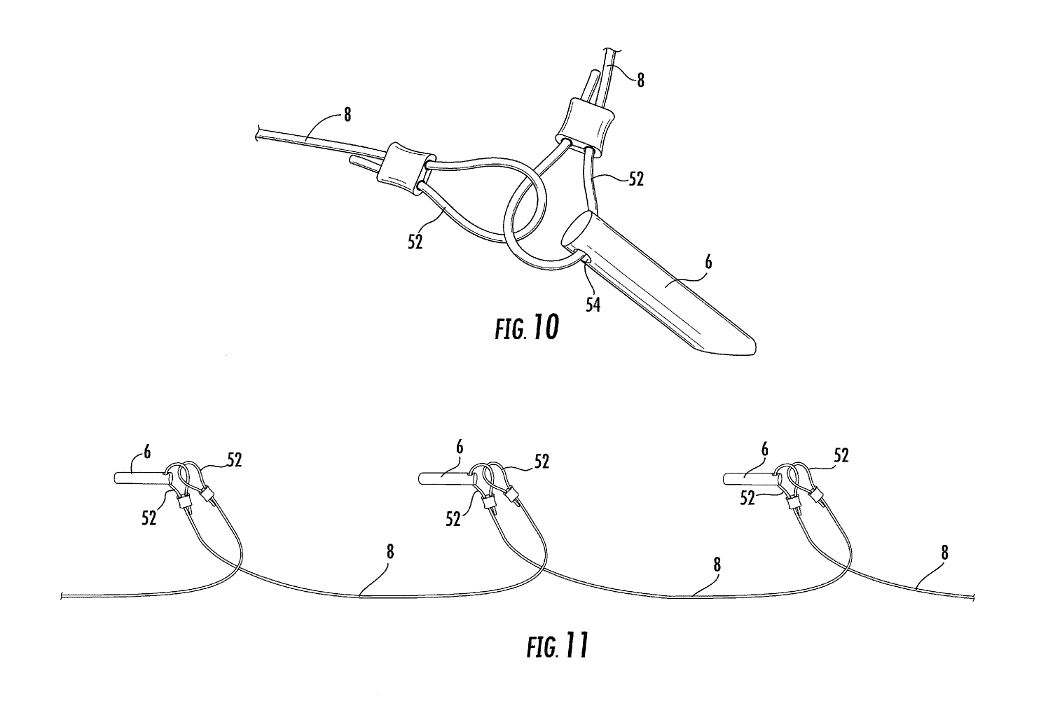

FIG. 10 demonstrates a preferred construction of the line 8. The line may be formed in segments, which each segment connected by a loop 52 that intersects a loop of an adjoining segment of the line as shown. One of the loops engages a void 54 formed in the pin 6.

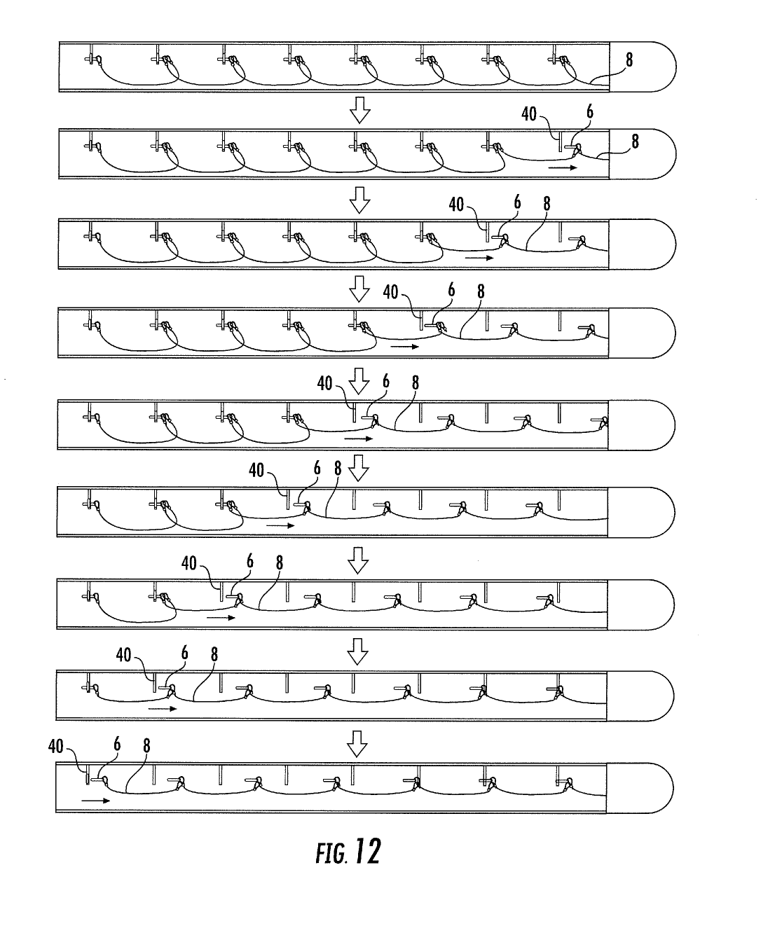

FIG. 11 shows the line 8 and pins 6 in isolation. Slack is provided in the line between the pins. In one embodiment, the pins have a generally consistent diameter along their length. In another embodiment, the pins taper from near a connection to the line to a smaller diameter approaching the free end of the pin. The taper assists with disengaging the pin from the loop as the line pulls the pin from the loop to open the associated hinged door.

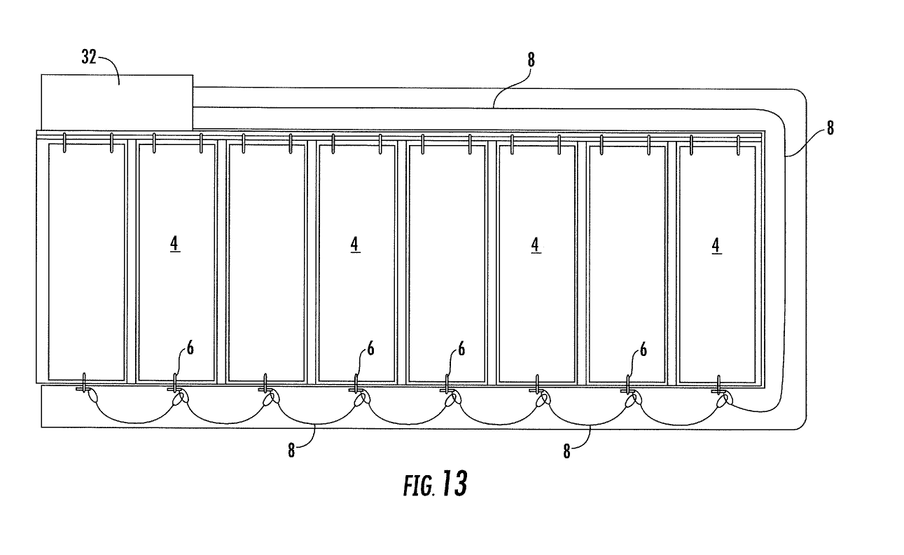

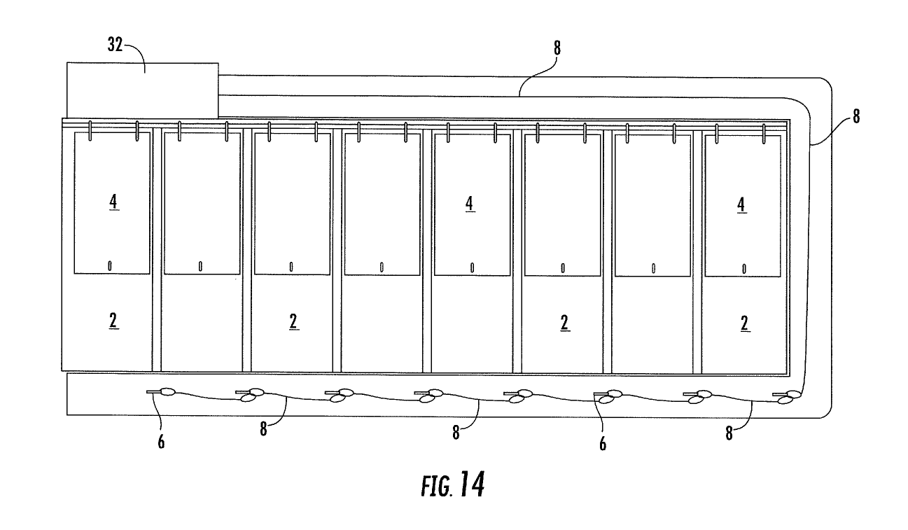

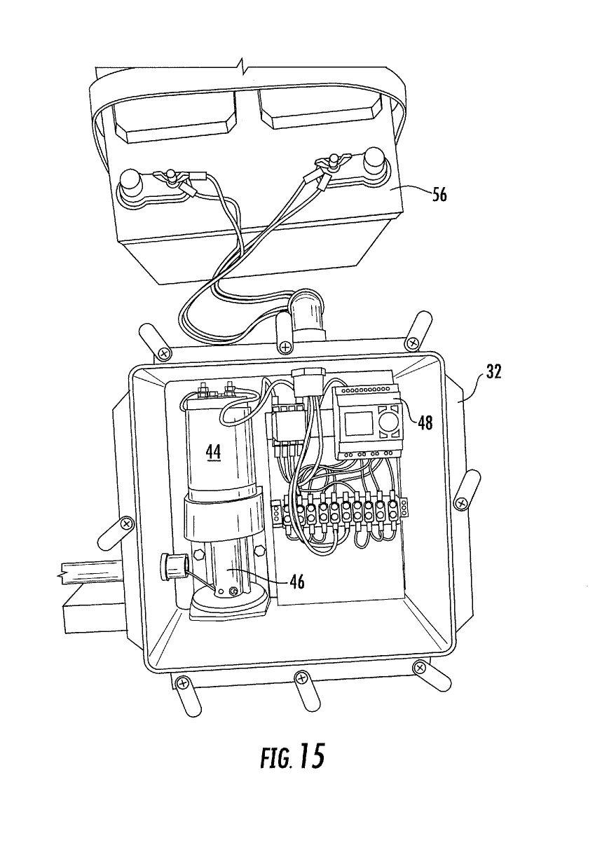

FIG. 12 demonstrates sequential operation of the device. The top view shows each pin 6 engaging a loop 40 that is associated with a hopper. Progressively moving downwardly in FIG. 12, the line is pulled taut by retracting the line for a certain distance, which pulls the first pin from its associated loop. However, in an embodiment, the line does not travel a sufficient distance to pull pins from the remaining loops. Accordingly, the remaining hinged doors remain closed after the first hinged door is opened by releasing the pin from the loop. As FIG. 12 shows, this operation is completed in sequence until all pins are pulled from their associated loops and all doors are opened. This is accomplished by pulling the line for a pre-determined distance so as to open the hinged doors of the hoppers in sequence.

The slack provided in the line 8 between the pins 6 allows the line to be taken up on a reel for a distance before the pin is pulled, which gains a mechanical advantage over a line that is taut between the pins. The use of pins, with slack in the line between the pins, is superior to the use of a cable running through the loop or other latch, which would be more likely to bind by the weight of the feed or other material contained within the hoppers pressing directly on the line and impinging the line. It is preferred that the length of the line between adjacent pins is 120% to 170% of the distance between the engagement point of the adjacent pins with the associated loops 40, and more preferred that the length of the line between adjacent pins is 130% to 160% of the distance between the engagement point of the adjacent pins with the associated loops.

The line is formed in segments in a preferred embodiment, with the segments preferred to be uniform in length so that the distance of travel of the line is consistent. The equal length segments promote accuracy in opening of the hoppers. While the use of sturdy material for the line, such as cable, means that replacement of the segments is rarely required, the use of equal length segments makes replacement easy and predictable.

In a most typical embodiment, the line is pulled a uniform distance that is sufficient to pull the pin from the loop. Actuation of motor pulling the line is terminated for a period of time. The period of time may be predetermined using a pre-set timer, or periodically actuated by a user, such as by remote actuation. However, in other embodiments, it is possible to time actuation of pulling of the line for a period that disengages multiple pins, therefore opening multiple hinged doors, as long as the multiple doors to be opened are adjacent to each other.

In a preferred embodiment, an electric motor 44 has a reel 46 attached thereto. A timer 48 controls the actuation of the electric motor. The electric motor is actuated by the timer to operate for a period of time that is associated with the length of line that is taken up by the reel. As the reel takes up the line, it sequentially pulls the pins as described above to open the doors. The speed of the motor and time of actuation of the motor is coordinated with the length of line of line to be taken up by the reel.

The motor may be a DC motor powered by a battery 56, such as a 6, 12 or 24 battery. A deep cycle marine type battery may be used. The battery also provides power for the timer, and if used, remote actuation devices. Battery power is preferred when the device is used in remote locations, such as when providing feed for game. Other power sources, if available, could be used. The battery may be recharged by solar panels positioned on the device.

The line may be formed of materials and to a diameter that is sufficient to pull the pins away from the loops as described. The line may be formed of materials such as nylon or polypropylene, although it is preferred to use line formed of metals, and particularly corrosion resistant steel lines which are resistant to stretching and provide high strength. Corrosion resistant wound steel cable is preferred.

In use, a sufficient length of line is removed from the take up reel 46 so that each pin 6 is available at the metal loop 40 associated with the pin. Each hinged door 4 of each hopper 2 is pushed to the closed position and the associated loop is positioned through the front of the hopper. The associated pin is inserted in to each loop, holding each hinged door in the closed position. The required slack between pins is provided by the distance between each pin along the length of the line, so that no special care needs to be taken by the operator. Also, due to the slack in the line, the pins may be inserted into the loops of the hinged doors in any order, and no specific sequence is required. Some or all of the hoppers may be filled with material of desired composition desired through the top door or doors 22 of the container 20. The timer 48, if used, is then set with regard to the interval between openings of each hinged door.

It is important to make sure that the line is properly positioned relative to the reel 46 so that the first actuation of the motor 44 and reel pulls the line a sufficient distance to open the first door. If this is accomplished, then the rest of the doors will open as long as the time of actuation of the motor and reel is uniform. In one embodiment, when the line is attached to the reel, but otherwise fully extended, actuation sufficient to pull the first pin is assured due to the known length of the line.

The device then sequentially dispenses feed or other materials from each hopper according to a time interval selected by the user, by actuation of the motor and reel for the required time to remove a pin from its associated latch or loop. In one embodiment, the timer may be remotely set or actuated on demand by use of a GSM activated relay comprising a SIM chip connected to the GSM phone network. The device may be remotely actuated using a cellular telephone. The intervals between actuation of the motor and reel may be programmed in hours or days as determined by the user.

In another embodiment, electro-optical sensors are mounted so that when a door falls and “breaks” a beam, or the position of the hopper door is sensed as being open (see first hopper door positioned as in FIG. 2), actuation of the motor and reel is terminated by a GSM relay. The motor and reel may be actuated manually or from a smartphone, and actuation terminated by the optical sensor.

What is claimed:

1. A sequential dispensing device comprising:
a plurality of containers, each container comprising a storage area and a hinged door positioned below the storage area,
a plurality of pins, wherein each of the plurality of pins is associated with one of the plurality of containers;
a line, wherein the line is connected to each pin of the plurality of pins;
a reel upon which the line is wound;
wherein, in use, the hinged door of each container is positioned adjacent to an opening of the storage area of each container, the hinged door obstructing the opening of the storage area and holding the contents of the storage area within the container, with the hinged door held in position adjacent to the opening of the storage area by a pin of the plurality of pins that is associated with the container and which engages the container, and the reel is rotated at time intervals, sequentially pulling the line a predetermined distance, wherein the line sequentially pulls each pin away from the hinged door of the associated container and a side of the hinged door of the associated container falls away from the associated container.

2. A sequential dispensing device as described in claim 1, wherein when the plurality of pins engage the plurality of containers, portions of the line located between adjacent pins of the plurality of pins comprise slack in the line.

3. A sequential dispensing device as described in claim 1, further comprising a plurality of latches, wherein one of the plurality of latches is associated with each of the plurality of containers, and each of the plurality of pins engage a latch of a plurality of latches.

4. A sequential dispensing device as described in claim 1, further comprising a plurality of latches, wherein one of the plurality of latches is associated with each of the plurality of containers, and each of the plurality of pins engage a latch of a plurality of latches, and portions of the line that are located between pins of the plurality of pins comprise slack in the line.

5. A sequential dispensing device as described in claim 1, wherein the containers are in a side by side relationship.

6. A sequential dispensing device as described in claim 1, further comprising a timer, wherein the timer intermittently actuates rotation of the reel for a time that is sufficient to pull the line a distance that pulls one pin of plurality of pins from the container of the plurality of containers with which the pin is associated.

7. A sequential dispensing device as described in claim 1, further comprising a timer, wherein the timer intermittently actuates rotation of the reel for a time that is sufficient to pull the line a distance that pulls one pin of plurality of pins from the container of the plurality of containers with which the pin is associated, and the timer repeats intermitted actuation of rotation of the reel until all of the pins of the plurality of pins are pulled from all of the containers.

8. A sequential dispensing device as described in claim 1, further comprising a remote actuator for the reel.

9. A sequential dispensing device as described in claim 1, wherein an electric motor actuates rotation of the reel.

10. A sequential dispensing device as described in claim 1, wherein the line is formed in interconnected segments.

11. A sequential dispensing device as described in claim 1, wherein the line is formed in interconnected segments, with each segment connected to a pin of the plurality of pins.

12. A sequential dispensing device as described in claim 1, wherein the line is formed in interconnected segments, with each segment connected to a pin of the plurality of pins, and wherein the length of each interconnected segment of the line is longer than the distance between a point of attachment of a first pin of the plurality of pins to its associated container and a point of attachment of a second and adjacent pin of the plurality of pins to its associated container.
